(19) United States
(12) Patent Application Publication
(10) Pub. No.: US 2025/0304093 A1
(43) Pub. Date: Oct. 2, 2025

(54) CONTROL DEVICE, CONTROL METHOD, AND STORAGE MEDIUM

(71) Applicant: HONDA MOTOR CO., LTD., Tokyo (JP)

(72) Inventors: Hironori HIRATA, Tokyo (JP); Masashi KANESAKA, Tokyo (JP)

(73) Assignee: HONDA MOTOR CO., LTD., Tokyo (JP)

(21) Appl. No.: 19/066,160

(22) Filed: Feb. 28, 2025

(30) Foreign Application Priority Data
Mar. 27, 2024 (JP) 2024-050844

(51) Int. Cl. B60W 50/14; B60W 30/09; B60W 30/095; B60W 30/14; B60W 30/18

(52) U.S. Cl. CPC B60W 50/14; B60W 30/09; B60W 30/0956; B60W 30/146; B60W 30/181; B60W 2552/05; B60W 2554/4041; B60W 2554/406; B60W 2556/40

(57) ABSTRACT

A control device for a moving object, the control device includes: a data acquisition unit that acquires peripheral environment data of the moving object; and a movement assistance unit that determines a peripheral environment risk of the moving object based on the peripheral environment data and provides movement assistance for the moving object based on the peripheral environment risk. When the moving object moves across a first area and a second area with different attributes, the movement assistance unit provides predetermined movement assistance that prompts a user of the moving object to check for safety based on a comparison between a peripheral environment risk of the first area and a peripheral environment risk of the

### CROSS-REFERENCE TO RELATED APPLICATIONS

This application is based upon and claims the benefit of priority from prior Japanese patent application No. 2024-50844, filed on Mar. 27, 2024, the entire contents of which are incorporated herein by reference.

### TECHNICAL FIELD

The present disclosure relates to a control device, a control method, and a storage medium storing a control program.

### BACKGROUND ART

In recent years, efforts have been made to provide access to a sustainable transportation system in consideration of people vulnerable among traffic participants. In order to implement the above, focus has been placed on research and development on further improving safety and convenience of traffic by research and development related to self-driving techniques.

In the related art, it is known that an autonomous driving system that causes a vehicle to travel autonomously without requiring a driving operation of a user, route information of, for example, a general road, from a current position to a target position is generated based on information acquired by vehicle-mounted sensors and then the vehicle is caused to travel. It is also known that a route taken when a vehicle travels to a target position by a driving operation of a user, for example, in an area other than general roads, is stored, and when the vehicle travels toward the same target position or takes the same route, the vehicle is caused to travel based on the stored route history.

For example, JP2022-184506A describes a vehicle travel control device including: a position detection unit for detecting a position of an object around the vehicle, a road condition detection unit for detecting a road condition, an attribute selection unit for adding an attribute to an object detected by the position detection unit according to a road condition at the position of the object detected by the road condition detection unit when the object is present on a road detected by the road condition detection unit, and a travel control unit for executing travel control according to the attribute added by the attribute selection unit, in which the travel control unit executes control to temporarily stop the host vehicle in front of a pedestrian crossing when the attribute selection unit adds an attribute of slow pedestrian movement to the detected object.

### SUMMARY OF INVENTION

In the autonomous driving system in the related art, when a vehicle passes over an area between a general road and an outside of the road, for example, a sidewalk, the vehicle is stopped temporarily in front of the sidewalk and a user (driver) of the vehicle is requested to check for safety. However, in some locations (for example, overseas, such as North America), there is no rule that requires vehicles to temporarily stop when passing over a sidewalk, and therefore, if vehicles have to stop every time passing over a sidewalk, smooth flow of traveling may be disrupted. On the other hand, when a vehicle enters a busy general road from outside of a road with little traffic, it is necessary to temporarily stop and check for safety regardless of whether there is a sidewalk or not. JP2022-184506A describes that the vehicle stops temporarily in front of a pedestrian crossing when a pedestrian (an object with slow pedestrian movement) is detected as described above, but does not describe vehicle movement control on general roads or off roads in a state where no pedestrian is detected.

Aspects of the present disclosure relate to providing a control device, a control method, and a storage medium storing a control program that are capable of flexibly performing movement control on a moving object according to a travel state.

According to an aspect of the present disclosure, there is provided a control device for a moving object, the control device including:
a data acquisition unit that acquires peripheral environment data of the moving object; and
a movement assistance unit that determines a peripheral environment risk of the moving object based on the peripheral environment data and provides movement assistance for the moving object based on the peripheral environment risk, in which
when the moving object moves across a first area and a second area with different attributes, the movement assistance unit provides predetermined movement assistance that prompts a user of the moving object to check for safety based on a comparison between a peripheral environment risk of the first area and a peripheral environment risk of the second area.

According to another aspect of the present disclosure, there is provided a control method using a control device for a moving object, the control device including a data acquisition unit that acquires peripheral environment data of the moving object, and a movement assistance unit that determines a peripheral environment risk of the moving object based on the peripheral environment data and provides movement assistance for the moving object based on the peripheral environment risk, the control method including,
when the moving object moves across a first area and a second area with different attributes, providing, by the control device, predetermined movement assistance that prompts a user of the moving object to check for safety based on a comparison between a peripheral environment risk of the first area and a peripheral environment risk of the second area.

According to another aspect of the present disclosure, there is provided a non-transitory computer-readable storage medium storing a control program causing a control device for a moving object to execute a process, the control device including a data acquisition unit that acquires peripheral environment data of the moving object, and a movement assistance unit that determines a peripheral environment risk of the moving object based on the peripheral environment data and provides movement assistance for the moving object based on the peripheral environment risk, the process including,
when the moving object moves across a first area and a second area with different attributes, providing predetermined movement assistance that prompts a user of the moving object to check for safety based on a comparison between a peripheral environment risk of the first area and a peripheral environment risk of the second area.

According to aspects of the present disclosure, there may be provided a control device, a control method, and a storage medium storing a control program that are capable of flexibly performing movement control on a moving object according to a travel state, thereby contributing to development of a sustainable transportation system.

### BRIEF DESCRIPTION OF DRAWINGS

Exemplary embodiment(s) of the present invention will be described in detail based on the following figures, wherein:

FIG. 1 is a side view of an example of a vehicle 10 equipped with a control device according to the present disclosure;

FIG. 2 is a top view of the vehicle 10 shown in FIG. 1;

FIG. 3 is a block diagram showing an example of an internal configuration of the vehicle 10 shown in FIG. 1;

FIG. 4 is a diagram showing an example of movement of the vehicle 10 from a first area to a second area;

FIG. 5 is a diagram showing an example of movement of the vehicle 10 from the second area to the first area;

FIG. 6 is a flowchart showing an example of movement control by a control ECU 20;

FIG. 7 is a flowchart showing a first modification of the movement control by the control ECU 20;

FIG. 8 is a flowchart showing a second modification of the movement control by the control ECU 20;

FIG. 9 is a flowchart showing a third modification of the movement control by the control ECU 20;

FIG. 10 is a flowchart showing a fourth modification of the movement control by the control ECU 20;

FIG. 11 is a flowchart showing a fifth modification of the movement control by the control ECU 20; and

FIG. 12 is a flowchart showing a sixth modification of the movement control by the control ECU 20.

### DESCRIPTION OF EMBODIMENTS

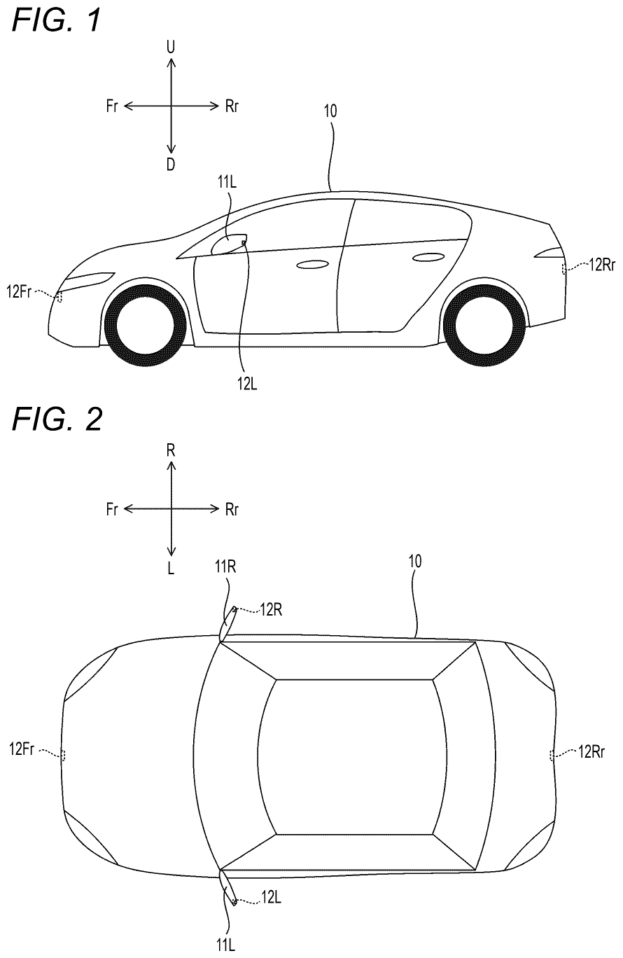

Hereinafter, an embodiment of a control device, a control method, and a storage medium storing a control program according to the present disclosure will be described with reference to the accompanying drawings. Note that the drawings are viewed in directions of reference numerals. In order to simplify and clarify the description in the present specification or the like, a front-rear direction, a left-right direction, and an upper-lower direction are described according to directions viewed from a driver of a vehicle 10 shown in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### Vehicle 10 Equipped With Control Device

FIG. 1 is a side view of an example of the vehicle 10 equipped with a control device in the present disclosure. FIG. 2 is a top view of the vehicle 10 shown in FIG. 1. The vehicle 10 is an example of a “moving object” in the present disclosure.

The vehicle 10 is an automobile including a drive source (not shown) and wheels including drive wheels driven by power of the drive source and steerable steered wheels. In the present embodiment, the vehicle 10 is a four-wheeled automobile having a pair of left and right front wheels and a pair of left and right rear wheels. The drive source of the vehicle 10 is, for example, an electric motor. Note that the drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by rotating about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

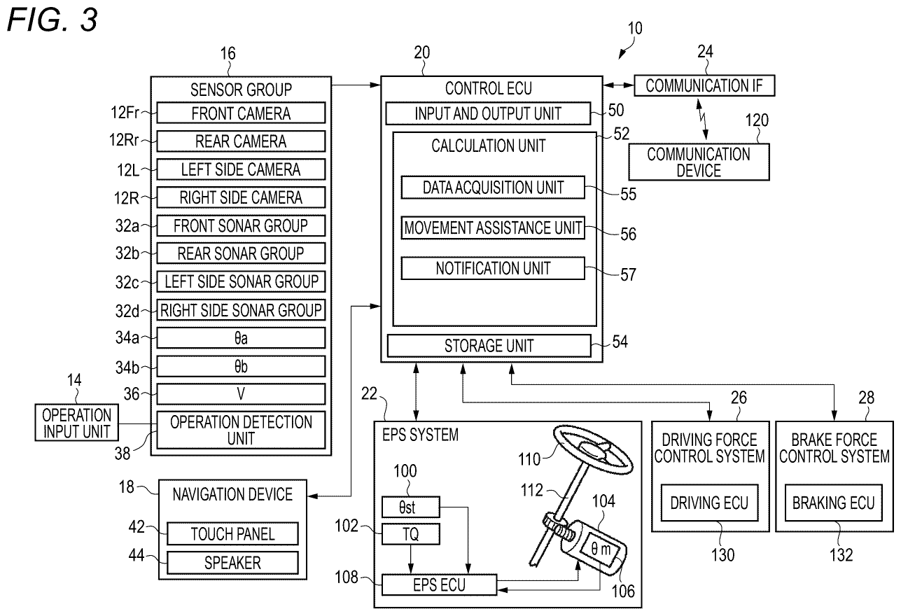

FIG. 3 is a block diagram showing an example of an internal configuration of the vehicle 10 shown in FIG. 1. As shown in FIG. 3, the vehicle 10 includes a sensor group 16, a navigation device 18, a control electronic control unit (ECU) 20, an electric power steering (EPS) system 22, and a communication IF 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire peripheral environment data (for example, peripheral images) for recognizing an peripheral environment of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining captured images from the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel. The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20. The operation input unit 14 includes various user interfaces such as a side mirror switch that switches between opened and closed states of the side mirrors 11L and 11R, and a shift lever (a selector lever or a selector).

The navigation device 18 detects a current position of the vehicle 10 by using, for example, a global positioning system (GPS), and guides the user along a route to a destination. The navigation device 18 includes a storage device (not shown) including a map information database. The navigation device 18 also includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes an autonomous parking button for requesting parking by automatic steering of the control ECU 20, and a support parking button for requesting support while parking the vehicle by an operation of the user. The exiting assistance button includes an autonomous exiting button for requesting exiting by the automatic steering of the control ECU 20, and a support exiting button for requesting support while exiting by an operation of the user. Note that a constituent element other than the touch panel 42, for example, an information terminal such as a smartphone or a tablet may be used as the input device or the display device.

Note that the “parking” is synonymous with, for example, “parking”. The “parking” is, for example, a stop as an occupant gets on or off the vehicle, and excludes a temporary stop due to a traffic signal or the like. Further, a “parking position” is a target position where the moving object (vehicle 10) is stopped, that is, a parking position.

The control ECU 20 includes an input and output unit 50, a calculation unit 52, and a storage unit 54. The calculation unit 52 is implemented by, for example, a central processing unit (CPU). The calculation unit 52 executes various types of control by controlling units based on a program stored in the storage unit 54. The calculation unit 52 receives and outputs signals from and to units connected to the control ECU 20 via the input and output unit 50. The control ECU 20 is an example of a “control device” in the present disclosure.

The storage unit 54 also stores information related to autonomous movement of the vehicle 10. For example, the storage unit 54 stores a route history when the vehicle 10 moves to a target position. The “route history” is a route history when the vehicle 10 moves to the target position by driving of the user. The route history includes information such as route data indicating a movement route, target position data indicating a target position, and peripheral environment data indicating a feature of a peripheral environment of the movement route and the target position.

The calculation unit 52 includes a data acquisition unit 55 that acquires the peripheral environment data of the vehicle 10, a movement assistance unit 56 that provides movement assistance for the vehicle 10, and a notification unit 57 that notifies information related to the movement assistance for the vehicle 10.

The data acquisition unit 55 acquires image data around the vehicle 10 captured by vehicle-mounted cameras such as the front camera 12Fr, the rear camera 12Rr, the left side camera 12L, and the right side camera 12R from the cameras. The peripheral environment data acquired by the data acquisition unit 55 may be, for example, navigation map data stored in a map information database of the navigation device 18, in addition to image data captured by vehicle-mounted cameras.

The movement assistance unit 56 determines a peripheral environment risk of the vehicle 10 based on the peripheral environment data acquired by the data acquisition unit 55, and provides movement assistance to move the vehicle 10 based on the determined peripheral environment risk. The movement assistance includes autonomous movement control in which an accelerator pedal (not shown), a brake pedal (not shown), and the operation input unit 14 are autonomously operated, and assisted movement control when the user (driver) operates the accelerator pedal, the brake pedal, and the operation input unit 14 to manually drive the vehicle 10.

For example, when the vehicle 10 moves across a first area and a second area with different attributes in the movement route to the target position, the movement assistance unit 56 provides predetermined movement assistance that prompts the user of the vehicle 10 (for example, the driver) to check for safety based on a comparison between a peripheral environment risk of the first area and a peripheral environment risk of the second area. The expression “moves across a first area and a second area” includes the vehicle 10 moving from the first area to the second area and the vehicle 10 moving from the second area to the first area. The “first area” includes, for example, general roads, areas with map data, and areas not registered in a memory of the storage unit 54 as a route history. The “second area” includes, for example, private roads, areas without map data, and areas registered in the memory of the storage unit 54 as a route history. Areas may also be divided according to freshness (time of update) of map information, and for example, an area with newer map information may be determined as the first area, and an area with older map information may be determined as a second area. The “peripheral environment risk” refers to, for example, whether the area where the vehicle 10 is traveling is a general road or a private land (including a private road), whether there is map data for navigation, and whether there is route history registered in memory.

In the case where the vehicle 10 moves from the first area to the second area, the movement assistance unit 56 does not provide the predetermined movement assistance when the peripheral environment risk of the second area is lower than the peripheral environment risk of the first area, and provides the predetermined movement assistance when the peripheral environment risk of the second area is higher than the peripheral environment risk of the first area. The expression “not provides the predetermined movement assistance” does not mean that any movement assistance that prompts the user to check for safety will not be provided, but rather that predetermined movement assistance will not be provided. For example, predetermined movement assistance that prompts the user to check for safety will be provided or not provided depending on the peripheral environment risk.

The movement assistance unit 56 determines a road type of the first area and the second area as the peripheral environment risk, and in a case where the first area is determined as a general road and the second area is determined as a private land, the movement assistance unit 56 does not provide the predetermined movement assistance when the vehicle 10 moves from the first area to the second area, and provides the predetermined movement assistance when the vehicle 10 moves from the second area to the first area.

The movement assistance unit 56 determines whether there is map data for navigation in the first area and the second area as the peripheral environment risk, and in a case where it is determined that there is map data in the first area and there is no map data in the second area, the movement assistance unit 56 does not provide the predetermined movement assistance when the vehicle 10 moves from the first area to the second area, and provides the predetermined movement assistance when the vehicle 10 moves from the second area to the first area.

The movement assistance unit 56 determines whether there is memory registered data in the first area and the second area as the peripheral environment risk, and in a case where it is determined that there is no memory registered data in the first area and there is memory registered data in the second area, the movement assistance unit 56 does not provide the predetermined movement assistance when the vehicle 10 moves from the first area to the second area, and provides the predetermined movement assistance when the vehicle 10 moves from the second area to the first area.

The movement assistance unit 56 determines the number of traffic participants in the first area and the second area as the peripheral environment risk when the vehicle 10 moves from the first area to the second area, and the movement assistance unit 56 does not provide the predetermined movement assistance when the number of traffic participants in the second area is smaller than the number of traffic participants in the first area, and provides the predetermined movement assistance when the number of traffic participants in the second area is larger than the number of traffic participants in the first area. For example, when the vehicle 10 moves across the first area and the second areas, the movement assistance unit 56 switches between whether to temporarily stop the vehicle 10 according to the result of the comparison between the numbers of traffic participants before and after the crossing.

In a case where the vehicle 10 moves from the first area to the second area, the movement assistance unit 56 determines entry directions of the vehicle 10 into the first area and the second area as the peripheral environment risk, and does not provide the predetermined movement assistance when the entry direction of the vehicle 10 is forward from the first area to the second area, and provides the predetermined movement assistance when the entry direction of the vehicle 10 is rearward from the first area to the second area. A traveling direction of the vehicle 10 can be determined based on a shift range, for example. The movement assistance unit 56 determines that the peripheral environment risk is higher in the case where the entry direction of the vehicle 10 is forward than in the case where the entry direction of the vehicle 10 is rearward, and provides the predetermined movement assistance when the entry direction is rearward.

The movement assistance unit 56 provides the predetermined movement assistance according to a state of traffic participants in at least one of the first area and the second area. The “state of traffic participants” refers to, for example, a relative position of the traffic participants with respect to the vehicle 10 (close to or far from the vehicle 10) and the number of traffic participants around the vehicle 10. For example, even when the first area is a general road and the second area is a private road and the vehicle 10 moves from the general road (first area) to the private road (second area), the movement assistance unit 56 causes the vehicle 10 to temporarily stop according to a state of a traffic participant, for example, in a case where the vehicle 10 is likely to come into contact with the traffic participant.

As the predetermined movement assistance, the movement assistance unit 56 performs movement control to temporarily stop the vehicle 10 before the vehicle 10 moves across the first area and the second area. The movement assistance unit 56 sets a deceleration of the vehicle 10 when the vehicle 10 is temporarily stopped according to the peripheral environment risk. For example, the movement assistance unit 56 increases the deceleration when temporarily stopping the vehicle 10 as the peripheral environment risk increases. The movement assistance unit 56 also sets a stop position of the vehicle 10 when the vehicle 10 is temporarily stopped according to the peripheral environment risk. For example, the movement assistance unit 56 sets the stop position to be closer to the vehicle 10 when temporarily stopping the vehicle 10 as the peripheral environment risk increases. Setting the stop position also includes setting a deceleration position (for example, deceleration start position).

As the predetermined movement assistance, the movement assistance unit 56 performs a notification via the notification unit 57 to prompt the user of the vehicle 10 to temporarily stop before the vehicle 10 moves across the first area and the second area. The movement assistance unit 56 sets an intensity of the notification to prompt the user to temporarily stop according to the peripheral environment risk. For example, the movement assistance unit 56 increases the intensity of the notification to prompt the user to temporarily stop as the peripheral environment risk increases.

The notification unit 57 performs the notification to prompt the user of the vehicle 10 to temporarily stop the vehicle 10 before the vehicle 10 moves across the first area and the second area.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for an operation of an occupant on the steering 110 and automatic steering during the parking assistance. The resolver 106 detects a rotation angle θm of the EPS motor 104. The EPS ECU 108 controls the entire EPS system 22. The EPS ECU 108 includes an input and output unit (not shown), a calculation unit (not shown), and a storage unit (not shown).

The communication IF 24 enables wireless communication with another communication device 120. Another communication device 120 includes a base station, a communication device of another vehicle, an information terminal such as a smartphone or a tablet that is portable for the user of the vehicle 10, and the like. For example, the communication IF 24 includes an ultra wide band (UWB, registered trademark) interface or the like that can execute UWB communication with the communication device 120.

The driving force control system 26 includes a drive ECU 130. The driving force control system 26 executes driving force control of the vehicle 10. The drive ECU 130 controls a driving force of the vehicle 10 by controlling an engine (not shown) or the like based on an operation performed by the user on the accelerator pedal (not shown).

The braking force control system 28 includes a brake ECU 132. The braking force control system 28 executes braking force control of the vehicle 10. The brake ECU 132 controls a braking force of the vehicle 10 by controlling a brake mechanism or the like (not shown) based on an operation performed by the user on the brake pedal (not shown).

### Movement of Vehicle 10 in First Area and Second Area

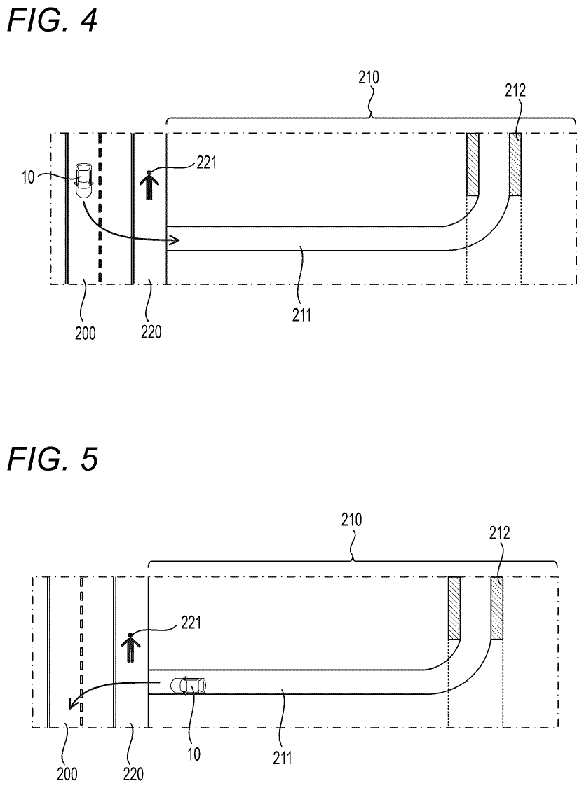

Next, with reference to FIGS. 4 and 5, a movement example in which the vehicle 10 moves across the first area and the second area with different attributes will be described.

FIG. 4 is a diagram showing an example in which the vehicle 10 moves from the first area to the second area. As shown in FIG. 4, the vehicle 10 with the user therein is to turn left on a general road 200 on which the vehicle 10 is traveling, as indicated by a solid arrow, and to enter a private land 210. In this example, the first area refers to the “general road 200”. The second area refers to the “private land 210”. The vehicle 10 that enters the private land 210 is to pass through a driveway 211 within the private land 210 and to enter a garage 212, which is a target position. Note that it is assumed that, for example, a pedestrian 221 is present on a sidewalk 220 of the general road 200.

FIG. 5 is a diagram showing an example in which the vehicle 10 moves from the second area to the first area. As shown in FIG. 5, the vehicle 10 with the user therein is to enter the general road 200, which is the first area, from the driveway 211 of the private land 210, which is the second area, as indicated by a solid arrow.

Note that in the case of FIGS. 4 and 5, the first area is the general road 200 and the second area is the private land 210, but the present disclosure is not limited thereto. For example, the area of the general road 200 in FIG. 4 and FIG. 5 may be set as the first area as an “area with map data”, and the area of the private land 210 may be set as the second area as an “area without map data”. The area of the general road 200 may be set as the first area as an “area without memory registration”, and the area of the private land 210 may be set as the second area as an “area with memory registration”.

### Example of Control by Control ECU 20

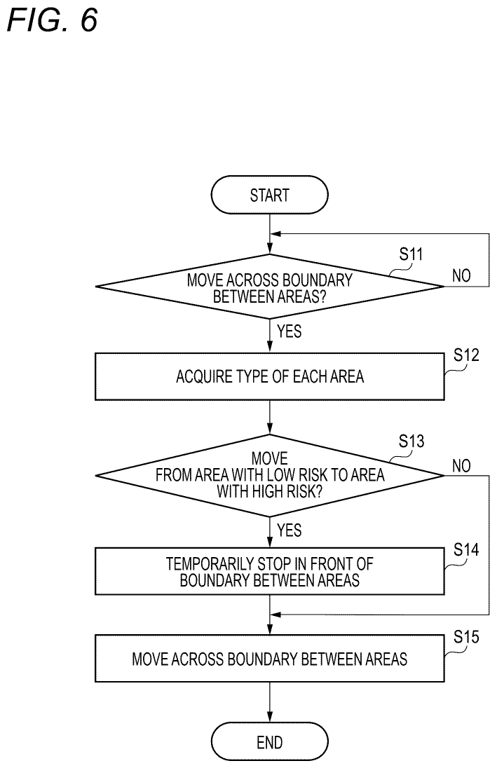

Next, the movement control by the control ECU 20 when the vehicle 10 moves will be described with reference to FIGS. 6 to 12. FIG. 6 is a flowchart showing an example of the movement control by the control ECU 20.

The control ECU 20 determines whether the vehicle 10 is moving across a boundary between areas (step S11). The boundary between areas is, for example, a boundary between the general road 200 and the private land 210 as described with reference to FIGS. 4 and 5. The meaning of “moving across” includes moving from the general road 200 to the private land 210 and moving from the private land 210 to the general road 200.

In step S11, if the vehicle is not moving across the boundary between areas (step S11: No), the control ECU 20 repeats the determination of step S11. In step S11, if the vehicle is moving across the boundary between areas (step S11: Yes), the control ECU 20 acquires a type of each area where the vehicle moves across (step S12). The type of each area refers to a type of the road on which the vehicle 10 travels, for example, as shown in FIG. 4 and FIG. 5, the general road 200 and the private land 210. The determination of whether the road is the general road 200 or the private land 210 may be made based on whether the road exists as road data on a map, or based on image data (peripheral environment data) captured by vehicle-mounted cameras.

Next, based on the type acquired in step S12, the control ECU 20 determines whether the movement of the vehicle 10 across the boundary between areas is from an area with a low peripheral environment risk to an area with a high peripheral environment risk (step S13).

In step S13, if the movement is from an area with a low peripheral environment risk to an area with a high peripheral environment risk (step S13: Yes), the control ECU 20 causes the vehicle 10 to temporarily stop in front of the boundary between areas (step S14). For example, as shown in FIGS. 4 and 5, when the first area is the general road 200 and the second area is the private land 210, the vehicle 10 is temporarily stopped before moving across the boundary between the two areas from the private land 210 to the general road 200 (see FIG. 5), that is, before leaving the driveway 211 of the private land 210 and entering the general road 200.

The control ECU 20 temporarily stops the vehicle 10 in front of the boundary between areas, and then starts moving the vehicle 10 again, and moves the vehicle 10 across the boundary between areas (step S15). For example, as indicated by the solid arrow in FIG. 5, the control ECU 20 causes the vehicle 10 to move across the boundary between the private land 210 and the general road 200 and to enter the general road 200.

On the other hand, in step S13, if the movement is not from an area with a low peripheral environment risk to an area with a high peripheral environment risk (step S13: No), the control ECU 20 causes the vehicle 10 to move across the boundary between areas without temporarily stopping the vehicle 10 in front of the boundary between areas (step S15).

In this way, in the case where the vehicle 10 moves across the general road 200 as the first area and the private land 210 as the second area, the control ECU 20 of the present embodiment performs movement control such that when the vehicle 10 moves from the private land 210 with a low peripheral environment risk to the general road 200 with a high peripheral environment risk, the vehicle 10 is temporarily stopped in front of the boundary between these areas, and when the vehicle 10 moves from the general road 200 with a high peripheral environment risk to the private land 210 with a low peripheral environment risk, the vehicle 10 is not temporarily stopped in front of the boundary between these areas. Therefore, the movement control on the vehicle 10 can be flexibly performed according to a travel state of areas where the vehicle 10 is traveling.

### First Modification

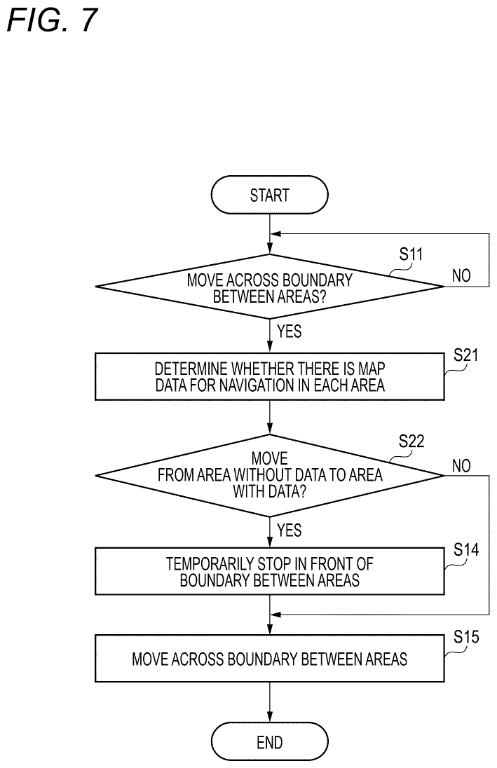

FIG. 7 is a flowchart showing a first modification of the movement control by the control ECU 20. As in the example of movement control described with reference to FIG. 6, the control ECU 20 determines whether the vehicle 10 is moving across a boundary between areas (step S11).

In step S11, if the vehicle is moving across the boundary between areas (step S11: Yes), the control ECU 20 determines whether there is map data for navigation in each area where the vehicle moves across (step S21).

Next, based on the determination result of step S21, the control ECU 20 determines whether the movement of the vehicle 10 across the boundary between areas is from an area without map data to an area with map data (step S22).

In step S22, if the movement is from an area without map data to an area with map data (step S22: Yes), the control ECU 20 causes the vehicle 10 to temporarily stop in front of the boundary between areas (step S14). For example, in FIGS. 4 and 5, when the general road 200 as the first area is an area with map data and the private land 210 as the second area is an area without map data, the vehicle 10 is temporarily stopped before moving across the boundary between the two areas from the private land 210 without map data to the general road 200 with map data (see FIG. 5). Note that an area without map data also includes newly constructed roads and areas where map data has not been updated.

On the other hand, in step S22, if the movement is not from an area without map data to an area with map data (step S22: No), the control ECU 20 proceeds to step S15 without temporarily stopping the vehicle 10 in front of the boundary between areas. The processing of step S15 is the same as the processing of step S15 in the movement control described with reference to FIG. 6.

In this way, in the case where the vehicle 10 moves across an area with map data as the first area and an area without map data as the second area, the control ECU 20 of the first modification performs movement control such that when the vehicle 10 moves from the area without map data and with a low peripheral environment risk to the area with map data and with a high peripheral environment risk, the vehicle 10 is temporarily stopped in front of the boundary between these areas, and when the vehicle 10 moves from the area with map data and with a high peripheral environment risk to the area without map data and with a low peripheral environment risk, the vehicle 10 is not temporarily stopped in front of the boundary between these areas. Therefore, the movement control on the vehicle 10 can be flexibly performed according to a travel state of areas where the vehicle 10 is traveling.

### Second Modification

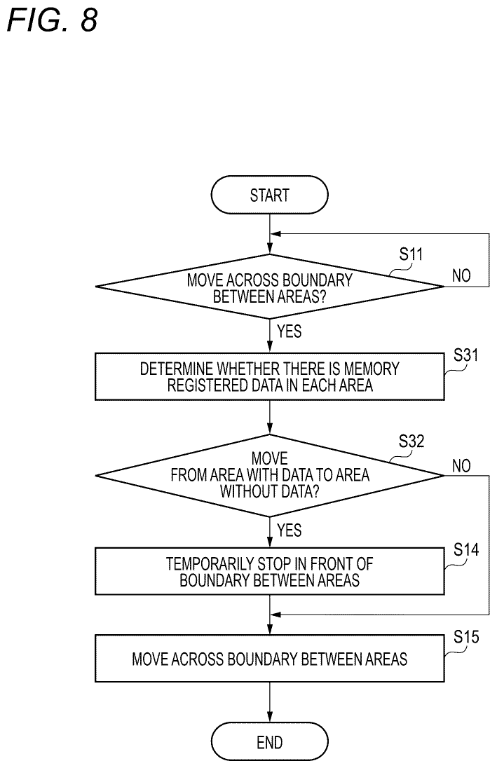

FIG. 8 is a flowchart showing a second modification of the movement control by the control ECU 20. As in the example of movement control described with reference to FIG. 6, the control ECU 20 determines whether the vehicle 10 is moving across a boundary between areas (step S11).

In step S11, if the vehicle is moving across the boundary between areas (step S11: Yes), the control ECU 20 determines whether there is memory registered data in each area where the vehicle moves across (step S31).

Next, based on the determination result of step S31, the control ECU 20 determines whether the movement of the vehicle 10 across the boundary between areas is from an area with memory registered data to an area without memory registered data (step S32).

In step S32, if the movement is from an area with memory registered data to an area without memory registered data (step S32: Yes), the control ECU 20 causes the vehicle 10 to temporarily stop in front of the boundary between areas (step S14). For example, in FIGS. 4 and 5, when the general road 200 as the first area is an area without memory registered data and the private land 210 as the second area is an area with memory registered data, the vehicle 10 is temporarily stopped before moving across the boundary between the two areas from the private land 210 with memory registered data to the general road 200 without memory registered data (see FIG. 5).

On the other hand, in step S32, if the movement is not from an area with memory registered data to an area without memory registered data (step S32: No), the control ECU 20 proceeds to step S15 without temporarily stopping the vehicle 10 in front of the boundary between areas. The processing of step S15 is the same as the processing of step S15 in the movement control described with reference to FIG. 6.

In this way, in the case where the vehicle 10 moves across an area without memory registered data as the first area and an area with memory registered data as the second area, the control ECU 20 of the second modification performs movement control such that when the vehicle 10 moves from the area with memory registered data and with a low peripheral environment risk to the area without memory registered data and with a high peripheral environment risk, the vehicle 10 is temporarily stopped in front of the boundary between these areas, and when the vehicle 10 moves from the area without memory registered data and with a high peripheral environment risk to the area with memory registered data and with a low peripheral environment risk, the vehicle 10 is not temporarily stopped in front of the boundary between these areas. Therefore, the movement control on the vehicle 10 can be flexibly performed according to a travel state of areas where the vehicle 10 is traveling.

### Third Modification

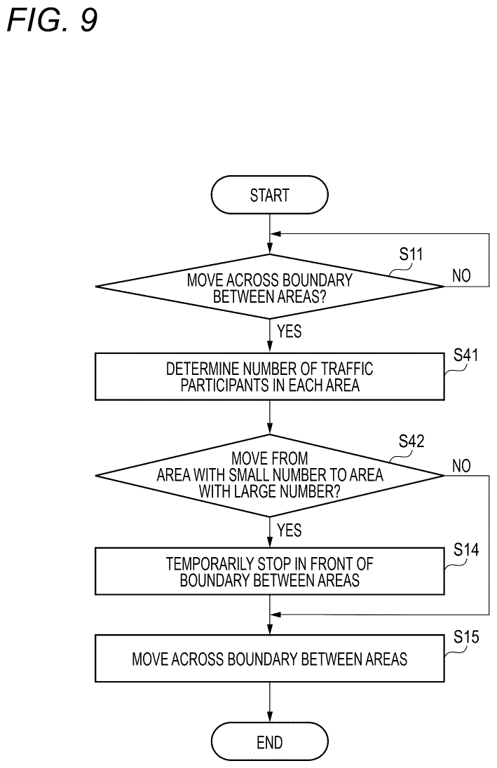

FIG. 9 is a flowchart showing a third modification of the movement control by the control ECU 20. As in the example of movement control described with reference to FIG. 6, the control ECU 20 determines whether the vehicle 10 is moving across a boundary between areas (step S11).

In step S11, if the vehicle is moving across the boundary between areas (step S11: Yes), the control ECU 20 determines the number of traffic participants of each area where the vehicle moves across (step S41).

Next, based on the determination result of step S41, the control ECU 20 determines whether the movement of the vehicle 10 across the boundary between areas is movement from an area with a small number of traffic participants to an area with a large number of traffic participants (step S42).

In step S42, if the movement is from an area with a small number of traffic participants to an area with a large number of traffic participants (step S42: Yes), the control ECU 20 causes the vehicle 10 to temporarily stop in front of the boundary between areas (step S14). For example, in FIGS. 4 and 5, when the general road 200 as the first area is an area with a large number of traffic participants and the private land 210 as the second area is an area with a small number of traffic participants, the vehicle 10 is temporarily stopped before moving across the boundary between the two areas from the private land 210 with a small number of traffic participants to the general road 200 with a large number of traffic participants (see FIG. 5).

On the other hand, in step S42, if the movement is not from an area with a small number of traffic participants to an area with a large number of traffic participants (step S42: No), the control ECU 20 proceeds to step S15 without temporarily stopping the vehicle 10 in front of the boundary between areas. The processing of step S15 is the same as the processing of step S15 in the movement control described with reference to FIG. 6.

In this way, in the case where the vehicle 10 moves across the first area and the second area, the control ECU 20 of the third modification performs movement control such that when the vehicle 10 moves from the area with a small number of traffic participants and with a low peripheral environment risk to the area with a large number of traffic participants and with a high peripheral environment risk, the vehicle 10 is temporarily stopped in front of the boundary between these areas, and when the vehicle 10 moves from the area with a large number of traffic participants and with a high peripheral environment risk to the area with a small number of traffic participants and with a low peripheral environment risk, the vehicle 10 is not temporarily stopped in front of the boundary between these areas. Therefore, the movement control on the vehicle 10 can be flexibly performed according to a travel state of areas where the vehicle 10 is traveling.

### Fourth Modification

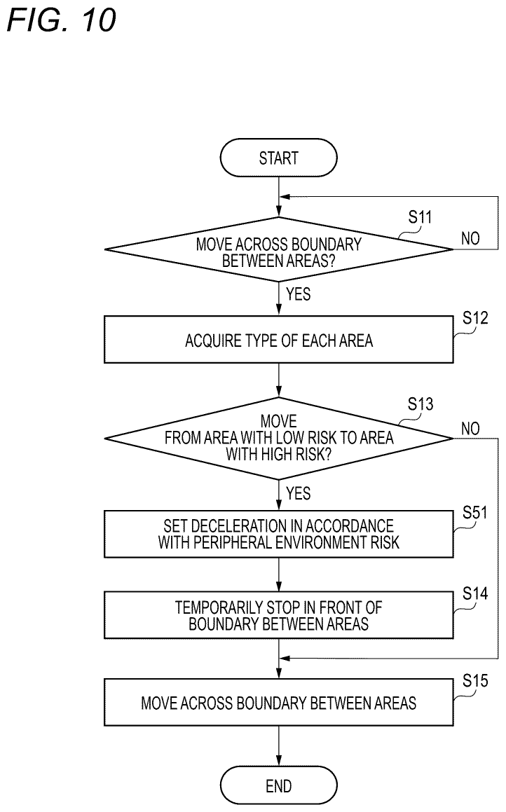

FIG. 10 is a flowchart showing a fourth modification of the movement control by the control ECU 20. As shown in FIG. 10, the processing from step S11 to step S13 is similar to the processing from step S11 to step S13 of the movement control described with reference to FIG. 6.

In step S13, if the movement is from an area with a low peripheral environment risk to an area with a high peripheral environment risk (step S13: Yes), the control ECU 20 sets the deceleration when stopping the vehicle 10 according to the peripheral environment risk (step S51). For example, the control ECU 20 increases the deceleration when temporarily stopping the vehicle 10 as the peripheral environment risk increases.

Next, the control ECU 20 causes the vehicle 10 to temporarily stop in front of the boundary between areas while decelerating the vehicle 10 at the deceleration set in step S51 (step S14). For example, as shown in FIGS. 4 and 5, when the first area is the general road 200 and the second area is the private land 210, the vehicle 10 is temporarily stopped at the set deceleration before moving across the boundary between the two areas from the private land 210 to the general road 200 (see FIG. 5), that is, before leaving the driveway 211 of the private land 210 and entering the general road 200.

The processing of step S15 and the processing in the case where step S13: No are the same as the processing of step S15 and the processing in the case where step S13: No in the movement control described with reference to FIG. 6.

In this way, in the case where the vehicle 10 moves across the general road 200 as the first area and the private land 210 as the second area, the control ECU 20 of the fourth modification performs movement control such that when the vehicle 10 moves from the private land 210 with a low peripheral environment risk to the general road 200 with a high peripheral environment risk, the vehicle 10 is temporarily stopped in front of the boundary between these areas at a deceleration set according to the high peripheral environment risk, and when the vehicle 10 moves from the general road 200 with a high peripheral environment risk to the private land 210 with a low peripheral environment risk, the vehicle 10 is not temporarily stopped in front of the boundary between these areas. Therefore, the movement control on the vehicle 10 can be more flexibly performed according to a travel state of areas where the vehicle 10 is traveling.

### Fifth Modification

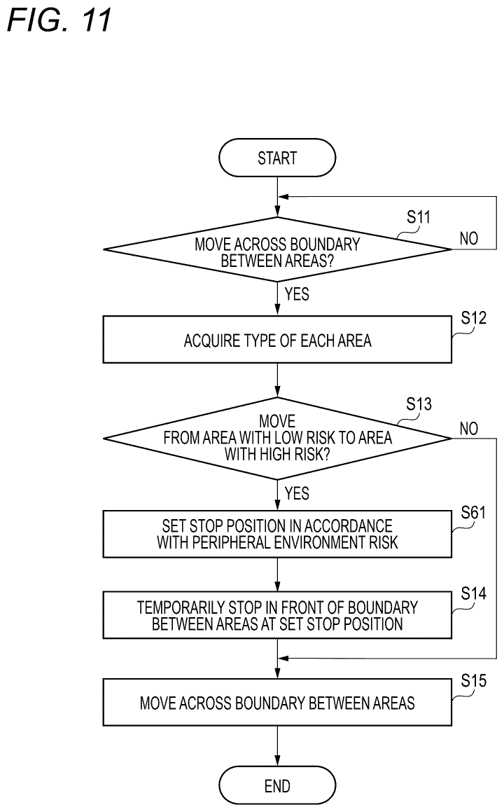

FIG. 11 is a flowchart showing a fifth modification of the movement control by the control ECU 20. As shown in FIG. 11, the processing from step S11 to step S13 is similar to the processing from step S11 to step S13 of the movement control described with reference to FIG. 6.

In step S13, if the movement is from an area with a low peripheral environment risk to an area with a high peripheral environment risk (step S13: Yes), the control ECU 20 sets a stop position at which the vehicle 10 is stopped according to the peripheral environment risk (step S61). For example, the control ECU 20 sets the stop position at which the vehicle 10 is stopped to be closer to the vehicle 10 as the peripheral environment risk increases.

Next, the control ECU 20 causes the vehicle 10 to temporarily stop in front of the boundary between areas at the stop position set in step S61 (step S14). For example, as shown in FIGS. 4 and 5, when the first area is the general road 200 and the second area is the private land 210, the vehicle 10 is temporarily stopped at the set stop position before moving across the boundary between the two areas from the private land 210 to the general road 200 (see FIG. 5), that is, before leaving the driveway 211 of the private land 210 and entering the general road 200.

The processing of step S15 and the processing in the case where step S13: No are the same as the processing of step S15 and the processing in the case where step S13: No in the movement control described with reference to FIG. 6.

Note that in the fifth modification, only the stop position of the vehicle 10 is set, but the present disclosure is not limited thereto. For example, in combination with the deceleration of the vehicle 10 set in the fourth modification shown in FIG. 10, the control ECU 20 may set the deceleration and the stop position at which the vehicle 10 is stopped according to the peripheral environment risk.

In this way, in the case where the vehicle 10 moves across the general road 200 as the first area and the private land 210 as the second area, the control ECU 20 of the fifth modification performs movement control such that when the vehicle 10 moves from the private land 210 with a low peripheral environment risk to the general road 200 with a high peripheral environment risk, the vehicle 10 is temporarily stopped at the stop position set according to the high peripheral environment risk in front of the boundary between these areas, and when the vehicle 10 moves from the general road 200 with a high peripheral environment risk to the private land 210 with a low peripheral environment risk, the vehicle 10 is not temporarily stopped in front of the boundary between these areas. Therefore, the movement control on the vehicle 10 can be more flexibly performed according to a travel state of areas where the vehicle 10 is traveling.

### Sixth Modification

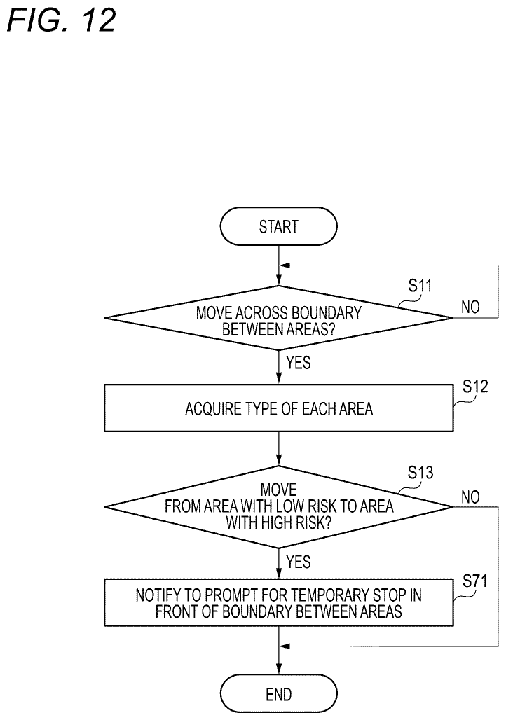

FIG. 12 is a flowchart showing a sixth modification of the movement control by the control ECU 20. As shown in FIG. 12, the processing from step S11 to step S13 is similar to the processing from step S11 to step S13 of the movement control described with reference to FIG. 6.

In step S13, if the movement is from an area with a low peripheral environment risk to an area with a high peripheral environment risk (step S13: Yes), the control ECU 20 performs a notification to prompt the vehicle 10 to stop temporarily in front of the boundary between areas (step S71). For example, as shown in FIGS. 4 and 5, when the first area is the general road 200 and the second area is the private land 210, a notification for prompting the vehicle 10 to temporarily stop is issued to the user of the vehicle 10 before the vehicle 10 moves across the boundary between the two areas from the private land 210 to the general road 200 (see FIG. 5), that is, before the vehicle 10 leaves the driveway 211 of the private land 210 and enters the general road 200.

On the other hand, in step S13, if the movement is not from an area with a low peripheral environment risk to an area with a high peripheral environment risk (step S13: No), the control ECU 20 does not perform a notification to prompt the vehicle 10 to stop temporarily in front of the boundary between areas.

Note that in the sixth modification, the movement of the vehicle 10 is not autonomous movement but assisted movement when the vehicle 10 is driven by the user.

In this way, in the case where the vehicle 10 moves across the general road 200 as the first area and the private land 210 as the second area, the control ECU 20 of the sixth modification issues a notification to the driver for prompting the vehicle 10 to temporarily stop in front of the boundary between these areas when the vehicle 10 moves from the private land 210 with a low peripheral environment risk to the general road 200 with a high peripheral environment risk, and does not issue a notification for prompting the vehicle 10 to temporarily stop in front of the boundary between these areas when the vehicle 10 moves from the general road 200 with a high peripheral environment risk to the private land 210 with a low peripheral environment risk. Therefore, the movement control on the vehicle 10 can be flexibly performed according to a travel state of the vehicle 10.

Note that the control method described in the embodiment described above may be implemented by executing a control program prepared in advance by a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

The embodiment of the present disclosure has been described above, but the present disclosure is not limited to the embodiment described above, and modifications, improvements, and the like may be made as appropriate.

In the above-described embodiment, an example in which the moving object is a vehicle (four-wheeled automobile) has been described, but the moving object is not limited thereto. For example, the moving object may be a vehicle such as a two-wheeled vehicle or a Segway. Further, the idea of the present disclosure is not limited to the vehicle, and may also be applied to a robot, a ship, an aircraft, or the like that includes a drive source and is movable by power of the drive source.

In the present specification, at least the following matters are described. Although corresponding constituent elements or the like in the embodiment described above are shown in parentheses, the present disclosure is not limited thereto.
(1) A control device (control ECU 20) for a moving object (vehicle 10), the control device including:
a data acquisition unit (data acquisition unit 25) that acquires peripheral environment data of the moving object; and
a movement assistance unit (movement assistance unit 56) that determines a peripheral environment risk of the moving object based on the peripheral environment data and provides movement assistance for the moving object based on the peripheral environment risk, in which
when the moving object moves across a first area and a second area with different attributes, the movement assistance unit provides predetermined movement assistance that prompts a user of the moving object to check for safety based on a comparison between a peripheral environment risk of the first area and a peripheral environment risk of the second area.

According to (1), in the case where the moving object moves across the first area and the second area with different attributes, since the predetermined movement assistance is provided based on the comparison between the peripheral environment risks of the two areas, the movement control on the moving object can be flexibly performed according to the travel state of the moving object.
(2) The control device according to (1), in which
in a case where the moving object moves from the first area to the second area, the movement assistance unit does not provide the predetermined movement assistance when the peripheral environment risk of the second area is lower than the peripheral environment risk of the first area, and provides the predetermined movement assistance when the peripheral environment risk of the second area is higher than the peripheral environment risk of the first area.

According to (2), when the moving object moves from the first area with a high peripheral environment risk to the second area with a low peripheral environment risk, the predetermined movement assistance is not provided, and when the moving object moves from the first area with a low peripheral environment risk to the second area with a high peripheral environment risk, the predetermined movement assistance is provided, and therefore, the movement control on the moving object can be flexibly performed according to the travel state.
(3) The control device according to (1) or (2), in which
the movement assistance unit determines a road type of the first area and the second area as the peripheral environment risk, and
in a case where the first area is determined as a general road and the second area is determined as a private land, the movement assistance unit does not provide the predetermined movement assistance when the moving object moves from the first area to the second area, and provides the predetermined movement assistance when the moving object moves from the second area to the first area.

According to (3), when the moving object moves from a general road to a private land, the predetermined movement assistance is not provided, and when the moving object moves from a private land to a general road, the predetermined movement assistance is provided, and therefore, the movement control on the moving object can be flexibly performed according to the travel state.
(4) The control device according to any one of (1) to (3), in which
the movement assistance unit determines whether there is map data for navigation in the first area and the second area as the peripheral environment risk, and
in a case where it is determined that there is map data in the first area and there is no map data in the second area, the movement assistance unit does not provide the predetermined movement assistance when the moving object moves from the first area to the second area, and provides the predetermined movement assistance when the moving object moves from the second area to the first area.

According to (4), when the moving object moves from an area with map data to an area without map data, the predetermined movement assistance is not provided, and when the moving object moves from an area without map data to an area with map data, the predetermined movement assistance is provided, and therefore, the movement control on the moving object can be flexibly performed according to the travel state.
(5) The control device according to any one of (1) to (4), in which
the movement assistance unit determines whether there is memory registered data in the first area and the second area as the peripheral environment risk, and
in a case where it is determined that there is no memory registered data in the first area and there is memory registered data in the second area, the movement assistance unit does not provide the predetermined movement assistance when the moving object moves from the first area to the second area, and provides the predetermined movement assistance when the moving object moves from the second area to the first area.

According to (5), when the moving object moves from an area without memory registered data to an area with memory registered data, the predetermined movement assistance is not provided, and when the moving object moves from an area with memory registered data to an area without memory registered data, the predetermined movement assistance is provided, and therefore, the movement control on the moving object can be flexibly performed according to the travel state.
(6) The control device according to any one of (1) to (5), in which
the movement assistance unit determines the number of traffic participants in the first area and the second area as the peripheral environment risk when the moving object moves from the first area to the second area, and
the movement assistance unit does not provide the predetermined movement assistance when the number of traffic participants in the second area is smaller than the number of traffic participants in the first area, and provides the predetermined movement assistance when the number of traffic participants in the second area is larger than the number of traffic participants in the first area.

According to (6), when the moving object moves from the first area with a large number of traffic participants to the second area with a small number of traffic participants, the predetermined movement assistance is not provided, and when the moving object moves from the first area with a small number of traffic participants to the second area with a large number of traffic participants, the predetermined movement assistance is provided, and therefore, the movement control on the moving object can be flexibly performed according to the travel state.
(7) The control device according to any one of (1) to (6), in which
the movement assistance unit provides the predetermined movement assistance according to a state of traffic participants in at least one of the first area and the second area.

As in (7), by providing the predetermined movement assistance according to the state of traffic participants in at least one of the first area and the second area, the movement control on the moving object can be more flexibly performed according to the travel state.
(8) The control device according to any one of (1) to (7), in which
the movement assistance unit performs movement control to temporarily stop the moving object before the moving object moves across the first area and the second area as the predetermined movement assistance.

As in (8), as the predetermined movement assistance for prompting the user of the moving object to check for safety, movement control of temporarily stopping the moving object is preferable.
(9) The control device according to (8), in which
the movement assistance unit sets a deceleration of the moving object according to the peripheral environment risk when temporarily stopping the moving object.

As in (9), it is preferable that the deceleration when temporarily stopping the moving object is set according to the peripheral environment risk.
(10) The control device according to (8) or (9), in which
the movement assistance unit sets a stop position according to the peripheral environment risk when temporarily stopping the moving object.

As in (10), it is preferable to set the stop position when temporarily stopping the moving object according to the peripheral environment risk.
(11) The control device according to any one of (1) to (10), in which
the movement assistance unit performs a notification to prompt the user to temporarily stop the moving object before the moving object moves across the first area and the second area as the predetermined movement assistance.

According to (11), by notifying the user to temporarily stop the moving object according to the peripheral environment risk before the moving object moves across the first area and the second area, the movement control on the vehicle 10 can be flexibly performed according to the travel state.
(12) The control device according to (11), in which
the movement assistance unit sets an intensity of the notification according to the peripheral environment risk.

As in (12), it is preferable to set the intensity of the notification for prompting the user to temporarily stop the moving object according to the peripheral environment risk.
(13) A control method using a control device for a moving object, the control device including a data acquisition unit that acquires peripheral environment data of the moving object, and a movement assistance unit that determines a peripheral environment risk of the moving object based on the peripheral environment data and provides movement assistance for the moving object based on the peripheral environment risk, the control method including
when the moving object moves across a first area and a second area with different attributes, providing, by the control device, predetermined movement assistance that prompts a user of the moving object to check for safety based on a comparison between a peripheral environment risk of the first area and a peripheral environment risk of the second area.

According to (13), in the case where the moving object moves across the first area and the second area with different attributes, since the predetermined movement assistance is provided based on the comparison between the peripheral environment risks of the two areas, the movement control on the moving object can be flexibly performed according to the travel state of the moving object.
(14) A non-transitory computer-readable storage medium storing a control program causing a control device for a moving object to execute a process, the control device including a data acquisition unit that acquires peripheral environment data of the moving object, and a movement assistance unit that determines a peripheral environment risk of the moving object based on the peripheral environment data and provides movement assistance for the moving object based on the peripheral environment risk, the process including
when the moving object moves across a first area and a second area with different attributes, providing predetermined movement assistance that prompts a user of the moving object to check for safety based on a comparison between a peripheral environment risk of the first area and a peripheral environment risk of the second area.

According to (14), in the case where the moving object moves across the first area and the second area with different attributes, since the predetermined movement assistance is provided based on the comparison between the peripheral environment risks of the two areas, the movement control on the moving object can be flexibly performed according to the travel state of the moving object.

What is claimed is:

1. A control device for a moving object, the control device comprising:
a data acquisition unit that acquires peripheral environment data of the moving object; and
a movement assistance unit that determines a peripheral environment risk of the moving object based on the peripheral environment data and provides movement assistance for the moving object based on the peripheral environment risk, wherein
when the moving object moves across a first area and a second area with different attributes, the movement assistance unit provides predetermined movement assistance that prompts a user of the moving object to check for safety based on a comparison between a peripheral environment risk of the first area and a peripheral environment risk of the second area.

2. The control device according to claim 1, wherein
in a case where the moving object moves from the first area to the second area, the movement assistance unit does not provide the predetermined movement assistance when the peripheral environment risk of the second area is lower than the peripheral environment risk of the first area, and provides the predetermined movement assistance when the peripheral environment risk of the second area is higher than the peripheral environment risk of the first area.

3. The control device according to claim 1, wherein
the movement assistance unit determines a road type of the first area and the second area as the peripheral environment risk, and
in a case where the first area is determined as a general road and the second area is determined as a private land, the movement assistance unit does not provide the predetermined movement assistance when the moving object moves from the first area to the second area, and provides the predetermined movement assistance when the moving object moves from the second area to the first area.

4. The control device according to claim 1, wherein
the movement assistance unit determines whether there is map data for navigation in the first area and the second area as the peripheral environment risk, and
in a case where it is determined that there is map data in the first area and there is no map data in the second area, the movement assistance unit does not provide the predetermined movement assistance when the moving object moves from the first area to the second area, and provides the predetermined movement assistance when the moving object moves from the second area to the first area.

5. The control device according to claim 1, wherein
the movement assistance unit determines whether there is memory registered data in the first area and the second area as the peripheral environment risk, and
in a case where it is determined that there is no memory registered data in the first area and there is memory registered data in the second area, the movement assistance unit does not provide the predetermined movement assistance when the moving object moves from the first area to the second area, and provides the predetermined movement assistance when the moving object moves from the second area to the first area.

6. The control device according to claim 1, wherein
the movement assistance unit determines the number of traffic participants in the first area and the second area as the peripheral environment risk when the moving object moves from the first area to the second area, and
the movement assistance unit does not provide the predetermined movement assistance when the number of traffic participants in the second area is smaller than the number of traffic participants in the first area, and provides the predetermined movement assistance when the number of traffic participants in the second area is larger than the number of traffic participants in the first area.

7. The control device according to claim 2, wherein
the movement assistance unit provides the predetermined movement assistance according to a state of traffic participants in at least one of the first area and the second area.

8. The control device according to claim 1, wherein
the movement assistance unit performs movement control to temporarily stop the moving object before the moving object moves across the first area and the second area as the predetermined movement assistance.

9. The control device according to claim 8, wherein
the movement assistance unit sets a deceleration of the moving object according to the peripheral environment risk when temporarily stopping the moving object.

10. The control device according to claim 8, wherein
the movement assistance unit sets a stop position according to the peripheral environment risk when temporarily stopping the moving object.

11. The control device according to claim 1, wherein
the movement assistance unit performs a notification to prompt the user to temporarily stop the moving object before the moving object moves across the first area and the second area as the predetermined movement assistance.

12. The control device according to claim 11, wherein
the movement assistance unit sets an intensity of the notification according to the peripheral environment risk.

13. A control method using a control device for a moving object, the control device including a data acquisition unit that acquires peripheral environment data of the moving object, and a movement assistance unit that determines a peripheral environment risk of the moving object based on the peripheral environment data and provides movement assistance for the moving object based on the peripheral environment risk, the control method comprising,
when the moving object moves across a first area and a second area with different attributes, providing, by the control device, predetermined movement assistance that prompts a user of the moving object to check for safety based on a comparison between a peripheral environment risk of the first area and a peripheral environment risk of the second area.

14. A non-transitory computer-readable storage medium storing a control program causing a control device for a moving object to execute a process, the control device including a data acquisition unit that acquires peripheral environment data of the moving object, and a movement assistance unit that determines a peripheral environment risk of the moving object based on the peripheral environment data and provides movement assistance for the moving object based on the peripheral environment risk, the process comprising,
when the moving object moves across a first area and a second area with different attributes, providing predetermined movement assistance that prompts a user of the moving object to check for safety based on a comparison between a peripheral environment risk of the first area and a peripheral environment risk of the second area.
